(19) United States
(12) Patent Application Publication
(10) Pub. No.: US 2024/0133567 A1
(43) Pub. Date: Apr. 25, 2024

(54) AIR PURIFYING APPARATUS

(71) Applicant: AweXome Ray, Inc., Anyang-si (KR)

(72) Inventors: Hong Soo CHOI, Seoul (KR); Jun Young CHOI, Seongnam-si (KR); Gihoon YOON, Seoul (KR); Namkyu LEE, Hwaseong-si (KR); Se Hoon GIHM, Seongnam-si (KR)

(21) Appl. No.: 18/070,294

(22) Filed: Nov. 28, 2022

(30) Foreign Application Priority Data
Oct. 20, 2022 (KR) 10-2022-0136581

(51) Int. Cl. F24F 8/30; F24F 7/06; F24F 12/00

(52) U.S. Cl. CPC F24F 8/30; F24F 7/06; F24F 12/006

(57) ABSTRACT

An air purifying apparatus includes an outer inlet which forms a flow path through which external air flows into the air purifying apparatus, an inner inlet which forms a flow path through which internal air flows into the air purifying apparatus, an outer outlet which forms a flow path through which air inside the air purifying apparatus is discharged to the outdoors, a charge part configured to ionize particles in the air flowing into the air purifying apparatus, a heat exchange dust collector configured to perform heat exchange between the air flowing into through the outer inlet and the air flowing into through the inner inlet, collect the ionized particles, and treat air inside the air purifying apparatus, and an inner outlet which forms a flow path through which the treated air is discharged into the indoors.

### CROSS-REFERENCE TO RELATED APPLICATION(S)

This application claims the benefit of Korean Patent Application No. 10-2022-0136581, filed on Oct. 21, 2022, in the Korean Intellectual Property Office, the disclosure of which is incorporated herein by reference.

### BACKGROUND

### Technical Field

The present disclosure relates to an air purifying apparatus.

### Description of the Related Art

An air purifying apparatus improves air quality by collecting foreign materials such as dusts, bacteria, and viruses in the air.

Meanwhile, an energy recovery ventilation (ERV) ventilates internal air by exhausting the internal air to the outdoors and supplying outdoor air into the indoors and, simultaneously, maintains an indoor temperature by preventing a temperature of external air flowing into the indoors through heat exchange between the external air and the internal air from significantly differing from the temperature of the internal air. In this way, the ERV may reduce energy consumption by recycling energy capable of being wasted due to heat loss in the internal air.

### BRIEF SUMMARY

An air purifying apparatus in the related art may remove foreign materials in the air, but the air purifying apparatus is not provided with a separate ventilation function. Thus, the air purifying apparatus cannot reduce a concentration of carbon dioxide in the indoors. The air purifying apparatus in the related art is provided with a ventilation function but cannot remove foreign materials in the air.

In order to solve the above matters, measures of installing both an air purifying apparatus and an ERV may be considered, but there is a matter in that costs are excessive and space utilization is inefficient. Therefore, it is beneficial to have a new technology having both functions of an air purifying apparatus and an ERV.

One or more embodiments of the present disclosure addresses the various technical problems in the related art including the problems identified above.

An aspect provides a new type of air purifying apparatus obtained by combining a function of an air purifying apparatus in the related art and a function of an energy recovery ventilation (ERV). Specifically, an aspect provides an air purifying apparatus for supplying external air to an indoor space, discharging internal air to the outdoors, performing heat exchange between the external air and the internal air, and collecting foreign materials present in the external air and the internal air.

The matters to be achieved by the present disclosure are not limited to the technical matters described above, and other matters may be inferred from the following example embodiments.

According to an aspect, there is provided an air purifying apparatus including an outer inlet which forms a flow path through which external air flows into the air purifying apparatus, an inner inlet which forms a flow path through which internal air flows into the air purifying apparatus, an outer outlet which forms a flow path through which air inside the air purifying apparatus is discharged to the outdoors, a charge part configured to ionize particles in the air flowing into the air purifying apparatus, a heat exchange dust collector configured to perform heat exchange between the air flowing into through the outer inlet and the air flowing into through the inner inlet, collect the ionized particles, and treat air inside the air purifying apparatus, and an inner outlet which forms a flow path through which the treated air is discharged into the indoors.

In addition, the heat exchange dust collector may include an external air flow path which is a flow path through which the air flowing into through the outer inlet flows, and an internal air flow path which is a flow path through which the air flowing into through the inner inlet flows. The wall surface of the external air flow path and the wall surface of the internal air flow path may have electrical conductivity, and the wall surface of the external air flow path and the wall surface of the internal air flow path may be thermally connected to each other.

In addition, the heat exchange dust collector may be configured such that the external air flow path and the internal air flow path are arranged in any one among a parallel flow manner, a counter flow manner, and a cross flow manner.

The charge part may include an electromagnetic wave generator provided with an emitter of a carbon nanotube material.

In addition, the air purifying apparatus may further include a flow path change part. The flow path change part may allow the air flowing into through the, inlet to be treated through the heat exchange dust collector and then to be discharged into the indoors through the inner outlet or allow the air flowing into through the inner inlet to be treated through the heat exchange dust collector and then to be discharged into the indoors through the inner outlet.

In addition, the flow path change part may include a damper.

In addition, the flow path change part may further include a driver configured to drive the damper.

In addition, the heat exchange dust collector may include a plurality of panels stacked and arranged in a state of being spaced apart from each other; at least one surface of each of the plurality of panels may have electrical conductivity, at least some of openings formed between the plurality of panels may form an entrance, and the formed entrance may communicate with the outer inlet, the inner inlet, the outer outlet, and the inner outlet to form a flow path for air treatment.

In addition, the heat exchange dust collector may further include a partition wall which forms a flow path by closing an area excluding the entrance among the openings formed between the plurality of panels.

In addition, the heat exchange dust collector may further include a flow path change part for opening or closing at least some of the openings formed between the plurality of panels.

In addition, the flow path change part may include a partition wall in the form of a damper configured to open and close at least some of the openings formed between the plurality of panels.

In addition, the flow path change part may include a movable partition wall including a partition wall opening configured to open or close at least some of the openings formed between the plurality of panels, and a driver configured to move the movable partition wall in a stacking direction of the plurality of panels and change an opening/closing state of the at least some openings.

In addition, the flow path change part may include a movable partition wall configured to open or close at least some of the openings formed between the plurality of panels, a rail provided in the stacking direction of the plurality of panels and configured to guide movement of the movable partition wall, and a driver configured to move the movable partition wall along the rail.

In addition, the air purifying apparatus may further include a blower generating a flow from the heat exchange dust collector to the inner outlet.

The charge part may be located between the outer inlet and the heat exchange dust collector and between the inner inlet and the heat exchange dust collector.

The details of other example embodiments are included in the detailed description and the accompanying drawings.

Additional aspects of example embodiments will be set forth in part in the description which follows and, in part, will be apparent from the description, or may be learned by practice of the disclosure.

### BRIEF DESCRIPTION OF THE SEVERAL VIEWS OF THE DRAWINGS

These and/or other aspects, features, and advantages of the disclosure will become apparent and more readily appreciated from the following description of example embodiments, taken in conjunction with the accompanying drawings of which:

FIG. 1 is a conceptual diagram illustrating an air purifying apparatus according to the present disclosure;

FIGS. 2A and 2B are cross-sectional view illustrating the air purifying apparatus according to the present disclosure;

FIGS. 3 and 4 are diagrams illustrating an example embodiment of a heat exchange dust collector according to the present disclosure;

FIG. 5 is a diagram illustrating an example embodiment of the heat exchange dust collector according to the present disclosure;

FIGS. 6 and 7 are conceptual diagrams illustrating a case in which the air purifying apparatus according to the present disclosure circulates internal air;

FIGS. 8 to 10 are diagrams illustrating an example embodiment of the heat exchange dust collector and a partition wall including a damper according to the present disclosure;

FIGS. 11 to 13 are diagrams illustrating an example embodiment of the heat exchange dust collector and the partition wall including an opening according to the present disclosure; and

FIG. 14 is a diagram illustrating an example embodiment of the heat exchange dust collector and the partition wall according to the present disclosure.

### DETAILED DESCRIPTION

Example embodiments described in the present disclosure are illustrative rather than limiting of the present disclosure, and those skilled in the art may design many alternative embodiments without departing from the scope of the present disclosure. The terms used in the example embodiments are selected, as much as possible, from general terms that are widely used at present while taking into consideration the functions obtained in accordance with the present disclosure, but these terms may be replaced by other terms based on intentions of those skilled in the art, customs, emergence of new technologies, or the like. Also, in a particular case, terms that are arbitrarily selected by the applicant of the present disclosure may be used. In this case, the meanings of these terms may be described in corresponding description parts of the disclosure. Accordingly, it should be noted that the terms used herein should be construed based on practical meanings thereof and the whole content of the present disclosure, rather than being simply construed based on names of the terms.

As used herein, the singular includes both the singular and the plural, unless the context clearly dictates otherwise.

Throughout the present specification, when a part “includes” certain components or certain operations, it does not necessarily mean that the part includes all components or operations, unless otherwise stated, it does not exclude that components or operations other than those listed throughout the claims or the present specification, it may merely mean to further include the components or operations.

In addition, terms including ordinal numbers such as first, second, and the like used herein may be used to describe various components, but the various components are not limited by these terms including the ordinal numbers. The above terms are used merely for the purpose of distinguishing one component from another component in some parts of the present specification in context. For example, without departing from the scope of the present disclosure, a first component may be referred to as a second component in other part of the present specification, and conversely, a second component may also be referred to as a first component in other part of the present specification.

In the present specification, terms such as “mechanism,” “element,” “part,” and “component” may be used broadly and are not limited to mechanical and physical components. These terms may include the meaning of a series of routines of software in association with a processor or the like.

In the present specification (especially, in the claims), the use of the term “the” and similar referential terms may be used in both the singular and the plural. In addition, when a range is described, individual values within the range are included (unless there is a description to the contrary), and each individual value constituting the range is described in the detailed description. Finally, unless there is an explicit order or description to the contrary, operations constituting a method may be rearranged and performed in an appropriate order, and the order of description of the operations is not necessarily limited. The use of all examples or terms (e.g., and the like) is merely for describing the technical idea in detail, and the scope is not limited by the examples or terms unless defined by the claims. Those skilled in the art may add various modifications, combinations, and changes to the example embodiments disclosed herein according to design conditions and factors to construct new embodiments falling within the scope of the claims or equivalents thereof.

Hereinafter, example embodiments of the present disclosure will be described with reference to the accompanying drawings. For brevity of the present specification and the drawings, various functional components that are not relevant to understanding the present disclosure have been omitted from the drawings. However, those skilled in the art may easily appreciate that various additional components may be included as a part of specific embodiments of the present disclosure to enable additional functions not specifically described in the present disclosure.

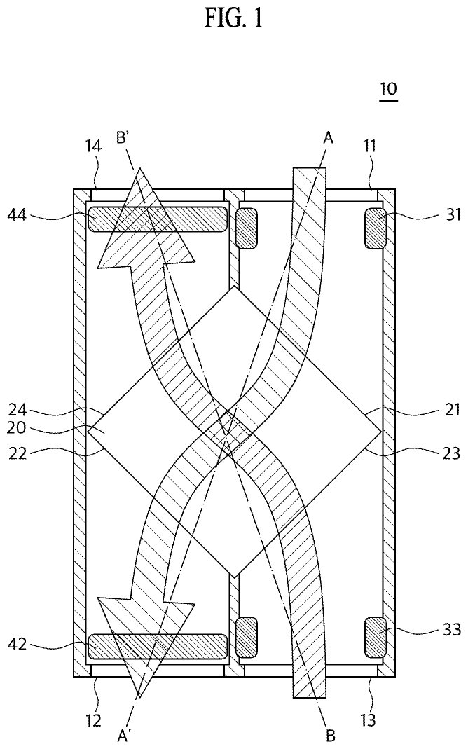

FIG. 1 is a conceptual diagram illustrating an air purifying apparatus 10 according to the present disclosure;

In an example embodiment, the air purifying apparatus 10 may include an outer inlet 11 which forms a flow path through which outdoor air flows into the air purifying apparatus 10, an inner inlet 13 which forms a flow path through which indoor air flows into the air purifying apparatus 10, an outer outlet 14 which forms a flow path through which air inside the air purifying apparatus 10 is discharged to the outdoors, charge parts 31 and 33 configured to ionize particles in the air flowing into the air purifying apparatus 10, a heat exchange dust collector 20 configured to perform heat exchange between the air flowing into through the outer inlet 11 and the air flowing into through the inner inlet 13 and collect ionized particles to treat the air inside the air purifying apparatus 10, and an inner outlet 12 through which the air treated by the heat exchange dust collector 20 is discharged into the indoors.

In an example embodiment, the charge parts 31 and 33 may each include an electromagnetic wave generator having an emitter made of a carbon nanotube material, but the present disclosure is not limited thereto, and the charge parts 31 and 33 may each be implemented as a device known in the art capable of ionizing foreign materials in the air.

In an example embodiment, an outer charge part 31 may be placed between the outer inlet 11 and the heat exchange dust collector 20. That is, the outer charge part 31 may ionize particles or foreign materials in air flowing into the air purifying apparatus 10 through the outer inlet 11. In an example embodiment, an inner charge part 33 may be placed between the inner inlet 13 and the heat exchange dust collector 20. That is, the inner charge part 33 may ionize particles or foreign materials in air flowing into the air purifying apparatus 10 through the outer inlet 13.

In an example embodiment, the heat exchange dust collector 20 may include a plurality of entrances 21, 22, 23, and 24. Air may flow into the heat exchange dust collector 20 through the plurality of entrances 21, 22, 23, and 24 or may flow out of the heat exchange dust collector 20. The heat exchange dust collector 20 may communicate with the outer inlet 11 through the first entrance 21, communicate with the inner outlet 12 through the second entrance 22, communicate with the inner inlet 13 through the third entrance 23, and communicate with the outer outlet 14 through the fourth entrance 24.

The heat exchange dust collector 20 may include a wall surface having electrical conductivity. In this way, in the air flowing into the heat exchange dust collector 20, particles or foreign materials ionized by the charge parts 31 and 33 may be collected on the wall surface of the heat exchange dust collector 20 due to an electric force. For example, a separate power or voltage is applied to the heat exchange dust collector 20 so that the wall surface of the heat exchange dust collector 20 may be positively charged, and the particles or foreign materials ionized by the charge parts 31 and 33 may be negatively charged. In this case, the particles or foreign materials which are negatively charged may adhere to the wall surface of the heat exchange dust collector 20, which is positively charged, by electrical attraction.

In an example embodiment, the heat exchange dust collector 20 may include an external air flow path through which the air flowing into through the outer inlet 11 flows, and an internal air flow path through which the air flowing into through the inner inlet 13 flows. The external air flow path and the internal air flow path may be spatially partitioned so that air in the external air flow path and air in the internal air flow path do not mix.

The wall surface of the external air flow path and the wall surface of the internal air flow path may have electrical conductivity, and the wall surface of the external air flow path and the wall surface of the internal air flow path may be thermally connected to each other. Since the wall surface of the external air flow path and the wall surface of the internal air flow path are thermally connected, heat transfer may occur between the external air flow path and the internal air flow path. An external air flow path and an internal air flow path, which are adjacent to each other, may share a wall member (for example, a panel). That is, the external air flow path and the internal air flow path, which are adjacent to each other, may be spatially partitioned by a shared wall member. For heat transfer between the external air flow path and the internal air flow path, the wall member may include a material having high thermal conductivity, and the material may be applied to the entire area of the wall member.

For example, the external air flow path may be a flow path from the first entrance 21 to the second entrance 22. In addition, the internal air flow path may be a flow path from the third entrance 23 to the fourth entrance 24.

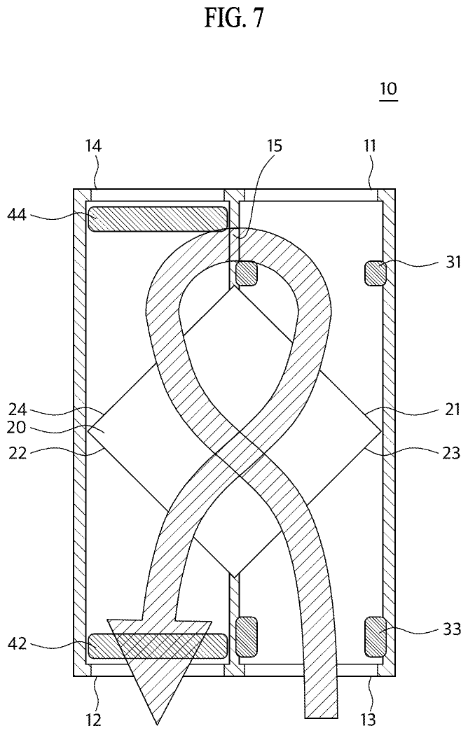

External air may flow into the air purifying apparatus 10 through the outer inlet 11, and the external air flowing into the air purifying apparatus 10 may pass through the outer charge part 31 to be ionized. In addition, internal air may flow into the air purifying apparatus 10 through the inner inlet 13, and the internal air flowing into the air purifying apparatus 10 may pass through the inner charge part 33 to be ionized. The ionization of the external air and the internal air is not limited to the structure shown in FIG. 1. Although not shown in FIG. 1, for example, the air flowing into the air purifying apparatus 10 through the inner inlet 13 may pass through the outer charge part 31 to be ionized, or the air flowing into the air purifying apparatus 10 through the outer inlet 11 may pass through the inner charge part 33 to be ionized. Details related to the above description will be described blow with reference to FIG. 7.

The external air passing through the outer charge part 31 may flow into the external air flow path of the heat exchange dust collector 20 through the first entrance 21. The wall surface of the external air flow path having electrical conductivity may be charged to collect ionized particles or foreign materials passing through the outer charge part 31. In addition, the internal air passing through the inner charge part 33 may flow into the internal air flow path of the heat exchange dust collector 20 through the third entrance 23. The wall surface of the internal air flow path having electrical conductivity may be charged to collect ionized particles or foreign materials passing through the inner charge part 33.

The wall surface of the external air flow path and the wall surface of the internal air flow path may be thermally connected to each other. This helps to generate heat exchange between the external air passing through the external air flow path and the internal air passing through the internal air flow path. In an example embodiment, the heat exchange dust collector 20 may be configured such that the external air flow path and the internal air flow path are arranged in any one among a parallel flow manner, a counter flow manner, and a cross flow manner. For example, referring to FIG. 1, the external air flow path and the internal air flow path may be disposed in a cross flow manner in which the external air flow path and the internal air flow path are orthogonal to each other. However, the present disclosure is not limited thereto, and the external air flow path and the internal air flow path are arranged at any angle or arrangement so that heat exchange between the external air passing through the external air flow path and the internal air passing through the internal air flow path may occur. Through the heat exchange, the external air passing through the external air flow path may be heated or cooled to be close to an initial temperature of the internal air, and the internal air passing through the internal air flow path may be heated or cooled to be close to an initial temperature of the external air.

As described above, the external air flow path and the internal air flow path of the heat exchange dust collector 20 may have both thermal conductivity and electrical conductivity, thereby generating heat exchange between the air passing through the external air flow path and the air passing the internal air flow path and, simultaneously, collecting ionized particles in each air using an electrostatic force.

The external air, on which the heat exchange and the purification treatment are completed, may be discharged to the outside of the heat exchange dust collector 20 through the second entrance 22 and may be discharged into the indoors through the inner outlet 12. In an example embodiment, for easily discharging the external air, on which the heat exchange and the purification treatment are completed, into the indoors, the air purifying apparatus 10 may include a blower 42 provided between the inner outlet 12 and the heat exchange dust collector 20. However, the position of the blower 42 is not limited thereto, and the blower 42 may be disposed at any position where the external air is allowed to flow to sequentially pass through the outer inlet 11, the heat exchange dust collector 20 (more specifically, the external air flow path), and the inner outlet 12. For example, the blower 42 may be disposed at an outer side of the outer inlet 11 or the inner outlet 12. Alternatively, for example, the blower 42 may be disposed inside the heat exchange dust collector 20, that is, in the external air flow path or the internal air flow path. Alternatively, for example, the blower 42 may be disposed between the outer inlet 11 and the first entrance 21.

The heat-exchanged internal air may be discharged to the outer side of the heat exchange dust collector 20 through the fourth entrance 24 and may be discharged to the outdoors through the outer outlet 14. In an example embodiment, for easily discharging the internal air to the outdoors, the air purifying apparatus 10 may include a blower 44 provided between the outer outlet 14 and the heat exchange dust collector 20. However, the position of the blower 44 is not limited thereto, and the blower 44 may be disposed at any position where the external air is allowed to flow to sequentially pass through the inner inlet 13, the heat exchange dust collector 20 (more specifically, the internal air flow path), and the outer outlet 14. For example, the blower 44 may be disposed at an outer side of the inner inlet 13 or the outer outlet 14. Alternatively, for example, the blower 44 may be disposed inside the heat exchange dust collector 20, that is, in the external air flow path or the internal air flow path. Alternatively, for example, the blower 44 may be disposed between the inner inlet 13 and the third entrance 23.

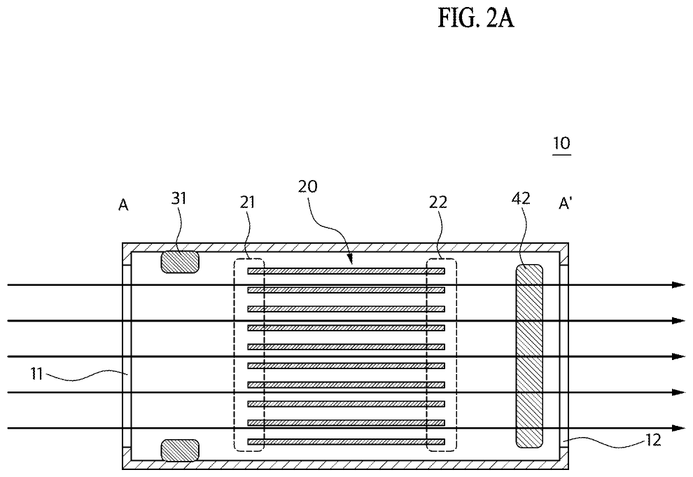

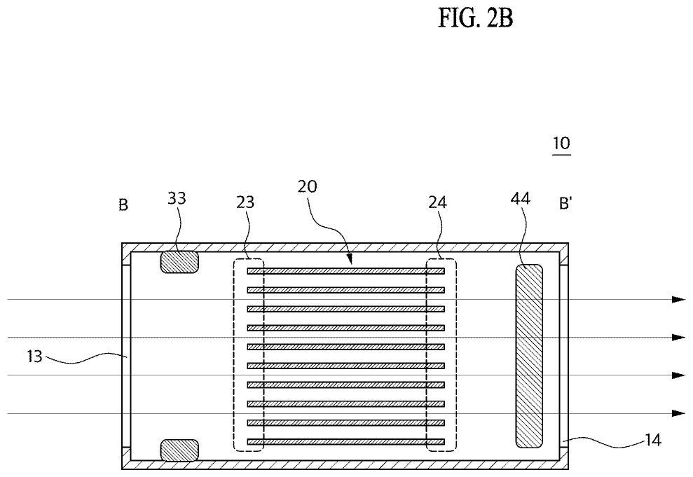

The shape of the heat exchange dust collector 20 shown in FIG. 1 is shown as a quadrangular shape, and the positions of the entrances 21, 22, 23, and 24 are shown as being located at corners of the quadrangular shape, but the shape of the heat exchange dust collector 20 and the positions and the number of entrances 21, 22, 23, and 24 are not limited thereto. For example, the heat exchanger dust collector 20 may be in the form of a hexagon, and the entrance may be located at each corner or vertex of the hexagon. Alternatively, two or more entrances may be located at one corner of a quadrangular shape or hexagon. In this case, the two or more entrances may be disposed in parallel with each other a corner or may be disposed in a vertical direction of FIG. 2A or 2B.

FIG. 2A is a cross-sectional view illustrating the air purifying apparatus 10 according to the present disclosure. Specifically, FIG. 2A is a cross-sectional view taken along plane A-A′ of the air purifying apparatus 10 shown in FIG. 1.

As described with reference to FIG. 1, the external air may flow into the air purifying apparatus 10 through the outer inlet 11. In this case, the external air may pass through the external charge part 31, and particles or foreign materials included in the external air may be ionized. The external air may flow into the heat exchange dust collector 20, more specifically, the external air flow path, through the first entrance 21. The wall surface of the external air flow path may be reversely charged with respect to the particles or foreign materials included in the external air, thereby collecting the particles or foreign materials included in the external air. The air in the external air flow path may be heat-exchanged with the air in the internal air flow path in the heat exchange dust collector 20. The external air may be discharged to the outer side of the heat exchange dust collector 20 through the second entrance 22 and may be discharged into the indoors through the inner outlet 12. The blower 42 may be used to generate such a flow of the external air.

FIG. 2B is a cross-sectional view illustrating the air purifying apparatus 10 according to the present disclosure. Specifically, FIG. 2B is a cross-sectional view taken along plane B-B′ of the air purifying apparatus 10 shown in FIG. 1.

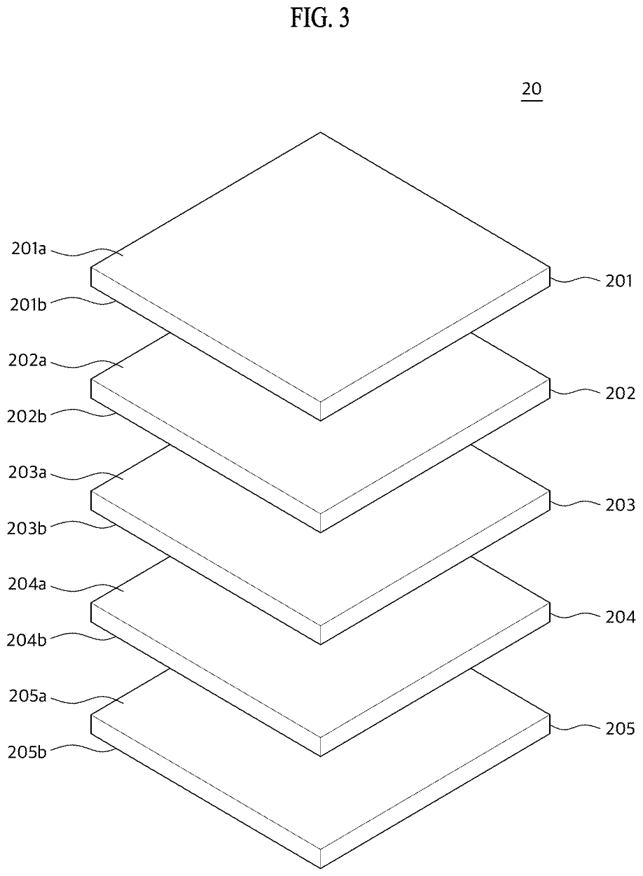

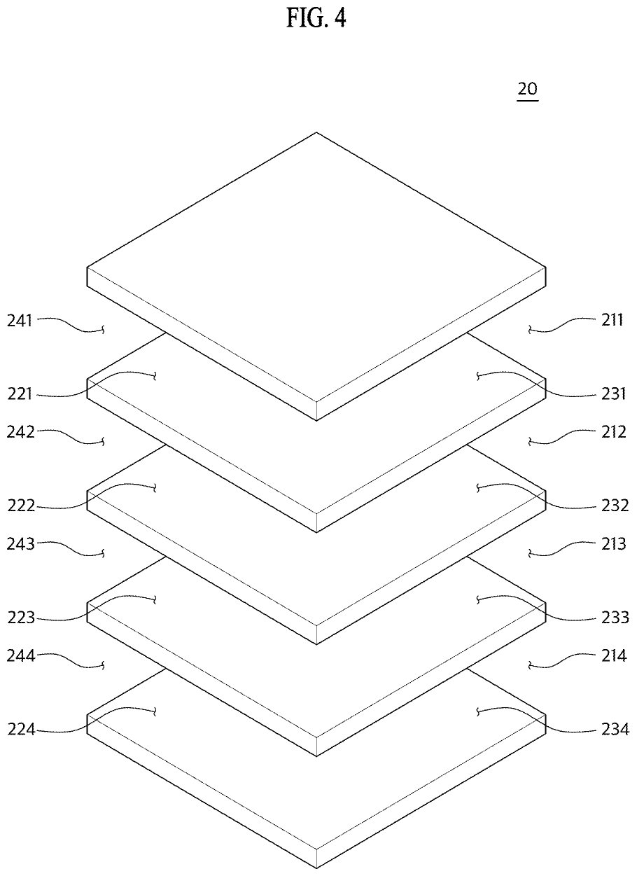

As described with reference to FIG. 1, the internal air may flow into the air purifying apparatus 10 through the inner inlet 13. In this case, the internal air may pass through the inner charge part 33, and particles or foreign materials included in the internal air may be ionized. The internal air may flow into the heat exchange dust collector 20, more specifically, the internal air flow path, through the third entrance 23. The wall surface of the internal air flow path may be reversely charged with respect to the particles or foreign materials included in the internal air, thereby collecting the particles or foreign materials included in the internal air. The air in the internal air flow path may be heat-exchanged with the air in the external air flow path in the heat exchange dust collector 20. The internal air may be discharged to the outer side of the heat exchange dust collector 20 through the fourth entrance 24 and may be discharged to the outdoors through the outer outlet 14. The blower 44 may be used to generate such a flow of the internal air. FIGS. 3 and 4 are diagrams illustrating an example embodiment of a heat exchange dust collector according to the present disclosure.

In an example embodiment, the heat exchange dust collector 20 may include a plurality of panels 201, 202, 203, 204, and 205 which are stacked and disposed in a state of being spaced apart from each other. Although five panels 201, 202, 203, 204, and 205 are shown in FIGS. 3 and 4, this is merely examples, and the heat exchange dust collector 20 may include more or fewer panels than those shown in FIGS. 3 and 4.

The plurality of panels 201, 202, 203, 204, and 205 may be stacked and disposed in a state of being spaced apart from each other. That is, the first panel 201 and the second panel 202 which are adjacent to each other may be stacked and disposed to be spaced apart from each other by a predetermined distance. Each of adjacent pairs of the second panel 202 and the third panel 203, the third panel 203 and the fourth panel 204, and the fourth panel 204 and the fifth panel 205 may also be disposed in the same manner as the pair of the first panel 201 and the second panel 202.

The first panel 201 may include a first upper surface 201a and a first lower surface 201b. The second panel 202 may include a second upper surface 202a and a second lower surface 202b. The third panel 203 may include a third upper surface 203a and a third lower surface 203b. The fourth panel 204 may include a fourth upper surface 204a and a fourth lower surface 204b. The fifth panel 205 may include a fifth upper surface 205a and a fifth lower surface 205b.

Air may pass between panels adjacent to each other. Specifically, the air may pass between facing surfaces of two panels adjacent to each other. In this case, the facing surface may constitute the wall surface of the external air flow path or the internal air flow path. For example, in the two adjacent panels 201 and 202, air may pass between the first lower surface 201b and the second upper surface 202a. That is, the first lower surface 201b and the second upper surface 202a may constitute the wall surface of the external air flow path or the internal air flow path.

In order to collect ionized particles or foreign materials included in the air passing between the facing surfaces of two adjacent panels, one or more of the facing surfaces may have electrical conductivity and may be reversely charged with respect to the ionized particles or foreign materials. For example, in order to collect the ionized particles or foreign materials included in the air passing between the first lower surface 201b and the second upper surface 202a, one or more of the first lower surface 201b and the second upper surface 202a may have electrical conductivity and may be reversely charged with respect to the ionized particles or foreign materials. When the ionized particles or foreign materials are negatively charged, one or more of the first lower surface 201b and the second upper surface 202a may be positively charged.

The above feature may can be equally applied to other adjacent panels, that is, between the two panels 202 and 203, the two panels 203 and 204, and the two panels 204 and 205.

Openings 211, 212, 213, 214, 221, 222, 223, 224, 231, 232, 233, 234, 241, 242, 243, and 244 are formed between the spaced panels of the heat exchange dust collector 20. Specifically, the 1-1 opening 211, the 2-1 opening 221, the 3-1 opening 231, and the 4-1 opening 241 may be formed between the first panel 201 and the second panel 202 of the heat exchange dust collector 20, the 1-2 opening 212, the 2-2 opening 222, the 3-2 opening 232, and the 4-2 opening 242 may be formed between the second panel 202 and the third panel 203, the 1-3 opening 213, the 2-3 opening 223, the 3-3 opening 233, and the 4-3 opening 243 may be formed between the third panel 203 and the fourth panel 204, and the 1-4 opening 214, the 2-4 opening 224, the 3-4 opening 234, and the 4-4 opening 244 may be formed between the fourth panel 204 and the fifth panel 205.

Each opening may be divided by a partition wall and a wall surface or a separate duct of the air purifying apparatus 10, which will be described below, and specific openings may be connected to each other to form a flow path and an entrance. For example, air may flow into between the first panel 201 and the second panel 202 through at least one among the 1-1 opening 211, the 2-1 opening 221, the 3-1 opening 231, and the 4-1 opening 241 or may be discharged from between the first panel 201 and the second panel 202 through at least one other opening. In order to form an air flow inside the heat exchange dust collector 20, and further to form an air flow inside the air purifying apparatus 10, the heat exchange dust collector 20 may be provided with a partition wall for guiding the air flow. The partition wall may be provided in an air flow direction between two adjacent panels. That is, the partition wall may form a flow path by closing an area excluding the entrance among the openings formed between the plurality of panels. The partition wall may be provided on an outer boundary of two adjacent panels or may be closely disposed in a space between the two panels.

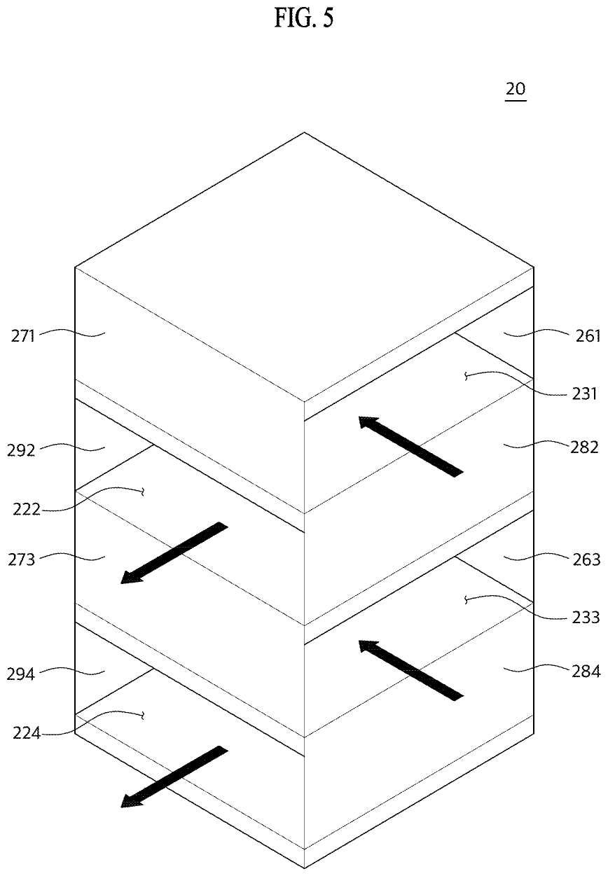

FIG. 5 is a diagram illustrating an example embodiment of the heat exchange dust collector 20 that shows an arrangement of one type of a partition wall for implementing the air flow of FIG. 1.

The heat exchange dust collector 20 of the present embodiment is provided with partition walls 261, 263, 271, 273, 282, 284, 292, and 294 which are alternatively disposed in a stacking direction.

In an example embodiment, a first partition wall set 261 and 263 and a second partition wall set 271 and 273 form the third entrance 23 and the fourth entrance 24 together with the panels, and a third partition wall set 282 and 284 and a fourth partition wall set 292 and 294 form the first entrance 21 and the second entrance 22 together with the panels. Specifically, the 1-1 partition wall 261 closes the 1-1 opening 211, the 1-3 partition wall 263 closes the 1-3 opening 213, the 2-1 partition wall 271 closes the 2-1 opening 221, the 2-3 partition wall 273 closes the 2-3 opening 223, the 3-2 partition wall 282 closes the 3-2 opening 232, the 3-4 partition wall 284 closes the 3-4 opening 234, the 4-2 partition wall 292 closes the 4-2 opening 242, and the 4-4 partition wall 294 closes the 4-4 opening 244.

In this case, the external air flowing into the air purifying apparatus 10 through the outer inlet 11 and passing through the outer charge part 31 may flow into the inside of the heat exchange dust collector 20 through the 1-2 opening 212 and the 1-4 opening 214, that is, the first entrance 21, may be guided by the third partition wall set 282 and 284 and the fourth partition wall set 292 and 294 to be discharged to the outside of the heat exchange dust collector 20 through the 2-2 opening 222 and the 2-4 opening 224, that is, the second entrance 22, and may be discharged to the indoors through the inner outlet 12. That is, the second lower surface 202b, the 3-2 partition wall 282, the third upper surface 203a, and the 4-2 partition wall 292 may form a first external air flow path. In addition, the fourth lower surface 204b, the 3-4 partition wall 284, the fifth upper surface 205a, and the 4-4 partition wall 294 may form a second external air flow path.

Also, in this case, the internal air flowing into the air purifying apparatus 10 through the inner inlet 13 may flow into the heat exchange dust collector 20 through the 3-1 opening 231 and the 3-3 opening 233, that is, the third entrance 23, may be guided by the first partition wall set 261 and 263 and the second partition wall set 271 and 273 to be discharged to the outside of the heat exchange dust collector 20 through the 4-1 opening 241 and the 4-3 opening 243, that is, the fourth entrance 24, and may be discharged to the outdoors through the outer outlet 14. That is, the first lower surface 201b, the 1-1 partition wall 261, the second upper surface 202a, and the 2-1 partition wall 271 may form a first internal air flow path. In addition, the third lower surface 203b, the 1-3 partition wall 263, the fourth upper surface 204a, and the 2-3 partition wall 273 may form a second internal air flow path.

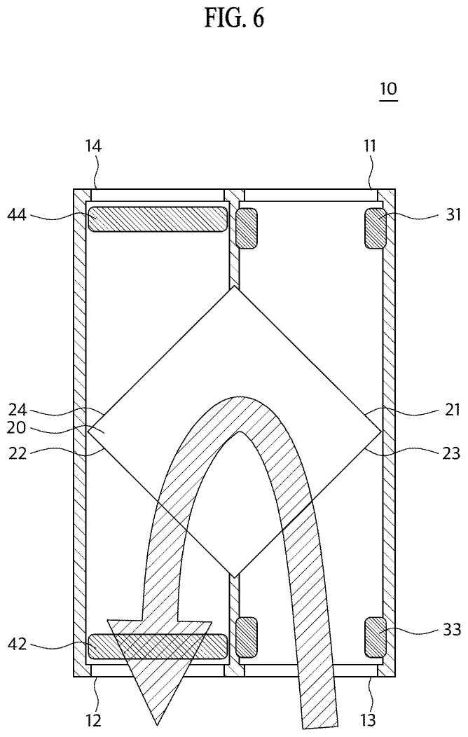

FIG. 6 is a conceptual diagram illustrating a case in which the air purifying apparatus according to the present disclosure circulates internal air.

The internal air may flow into the air purifying apparatus 10 through the inner inlet 13. The internal air flowing into the air purifying apparatus 10 may pass through the inner charge part 33. In this case, particles or foreign materials included in the internal air may be ionized by the inner charge part 33.

The internal air passing through the inner charge part 33 may flow into the heat exchange dust collector 20 through the third entrance 23. The wall surface of the heat exchange dust collector 20 or the wall surface of the flow path through which the internal air passes may be reversely charged with respect to the ionized particles or foreign materials included in the internal air. Therefore, after the internal air passes through the heat exchange dust collector 20, the ionized particles or foreign materials contained in the internal air may be collected by the heat exchange dust collector 20.

The internal air purified by the heat exchange dust collector 20 may be discharged from the heat exchange dust collector 20 through the second entrance 22 and may be discharged into the indoors through the inner outlet 12. When a user does not want to ventilate the internal air or introduce the external air into the indoors, this has an advantage of preventing the external air from flowing into the indoors and purifying merely the internal air.

In order to prevent the internal air flowing into the heat exchange dust collector 20 through the third entrance 23 from being discharged from the heat exchange dust collector 20 through the first entrance 21 or the fourth entrance 24, the first entrance 21 and the fourth entrance 24 may be closed.

FIG. 7 is a conceptual diagram illustrating a case in which the air purifying apparatus according to the present disclosure circulates internal air.

The internal air may flow into the air purifying apparatus 10 through the inner inlet 13. The internal air flowing into the air purifying apparatus 10 may pass through the inner charge part 33. In this case, particles or foreign materials included in the internal air may be ionized by the inner charge part 33.

The internal air passing through the inner charge part 33 may flow into the heat exchange dust collector 20 through the third entrance 23. The wall surface of the heat exchange dust collector 20 or the wall surface of the flow path through which the internal air passes may be reversely charged with respect to the ionized particles or foreign materials included in the internal air. Therefore, after the internal air passes through the heat exchange dust collector 20, the ionized particles or foreign materials contained in the internal air may be collected by the heat exchange dust collector 20.

The internal air purified by the heat exchange dust collector 20 may be discharged from the heat exchange dust collector 20 through the fourth entrance 24, may make a U-turn through an inner hollow 15 and re-flow into the heat exchange dust collector 20 through the first entrance 21, may be discharged from the heat exchange dust collector 20 through the second entrance 22, and may be discharged into the indoors through the inner outlet 12. When a user does not want to ventilate the internal air or introduce the external air into the indoors, this has an advantage of preventing the external air from flowing into the indoors and purifying merely the internal air. In this way, in order to induce the air flow, both the outer outlet 14 and the outer inlet 11 may be closed.

The air passing through the inner hollow 15 and making a U-turn to propagate may pass through the outer charge part 31. In this case, the particles or foreign materials included in the internal air may be ionized by the outer charge part 31. Since the air passing through the outer charge part 31 passes through the heat exchange dust collector 20, the ionized particles or foreign materials included in the air may be collected by the heat exchange dust collector 20. Due to the above structure, the outer charge part 31 may purify not only the external air flowing into the air purifying apparatus 10 through the outer inlet 11, but also the internal air flowing into the air purifying apparatus 10 through the inner inlet 13. In some cases, the operations of FIGS. 6 and 7 of closing the first entrance 21 and the fourth entrance 24 so that the indoor air circulates and the operation of FIG. 1 in which the external air and the internal air are exchanged are selectively implemented.

That is, in a specific embodiment, the air purifying apparatus 10 is necessary to selectively form a flow path sequentially passing through the outer inlet 11, the heat exchange dust collector 20, and the inner outlet 12 or a flow path passing through the inner inlet 13, the heat exchange dust collector 20, and the inner outlet 12. To this end, in an example embodiment, the air purifying apparatus 10 further includes a flow path change part. As shown in FIG. 1, the flow path change part may allow the air flowing into through the outer inlet 11 to be processed through the heat exchange dust collector 20 and then discharged into the indoors through the inner outlet 12 or, as shown in FIGS. 6 and 7, the flow path change part may allow the air flowing into through the inner inlet 13 to be treated through the heat exchange dust collector 20 and then discharged into the indoors through the inner outlet 12.

The flow path change part may open or close at least some of the first entrance 21, the second entrance 22, the third entrance 23, the fourth entrance 24, and the openings for forming the entrances and may change a flow path by opening or closing the outer inlet 11, the inner outlet 12, the inner inlet 13, the outer outlet 14, or the inner hollow 15. In one embodiment, the flow path change part may change the flow path by opening or closing all or some of one or more flow paths from the outer inlet 11, the inner outlet 12, the inner inlet 13, and the outer outlet 14 to the heat exchange dust collector 20. In order to open or close at least one among the entrances, the inlets, the outlets, and the inner hollow, the flow path change part may include a damper, a valve, or a movable partition wall. In addition, the flow path change part may further include a driver for driving the damper, the valve, or the movable partition wall. The driver may drive the damper, the valve, or the movable partition wall so as to open or close all or some of the entrances, the inlets, the outlets, or the flow paths.

In an example embodiment, the heat exchange dust collector may further include a flow path change part for opening or closing at least some of the openings formed between the plurality of panels.

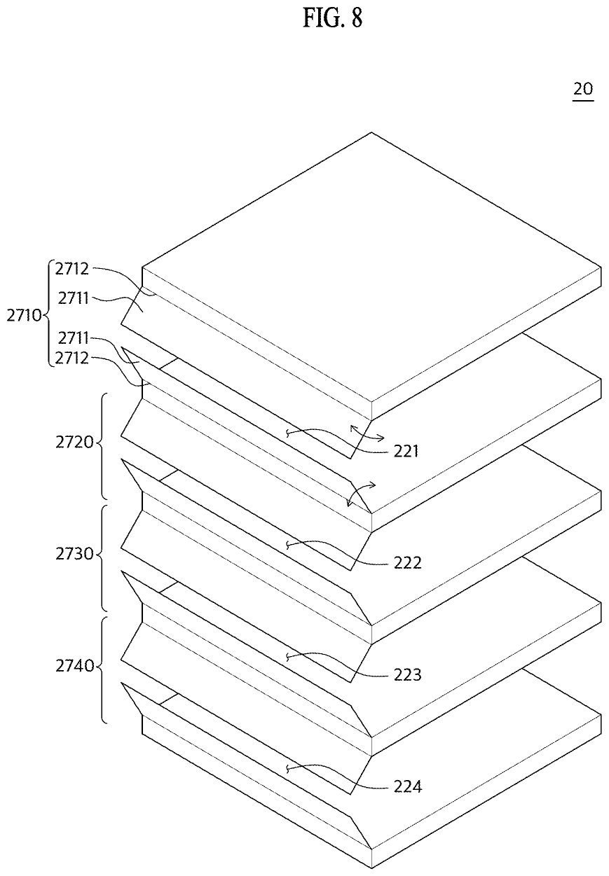

FIGS. 8 to 10 are diagrams illustrating an example embodiment of a heat exchange dust collector according to the present disclosure.

In an example embodiment, the partition wall of the heat exchange dust collector 20 may be implemented in a damper manner to change a flow path by selectively opening or closing each opening. For example, the 2-1 partition wall 271 shown in FIG. 5 may be provided in the form of a 2-1 damper 2710 as shown in FIG. 8. When the 2-1 damper 2710 is opened, the 2-1 opening 221 may be opened, and when the 2-1 damper 2710 is closed, the 2-1 opening 221 may be closed.

Similarly, the 2-2 partition wall 272 shown in FIG. 5 may be provided in the form of a 2-2 damper 2720 of FIG. 8, the 2-3 partition wall 273 shown in FIG. 5 may be provided in the form of a 2-3 damper 2730 of FIG. 8, and the 2-4 partition wall 274 shown in FIG. 5 may be provided in the form of a 2-4 damper 2740 of FIG. 8, and the dampers 2720, 2730, and 2740 may open or close the openings 222, 223, and 224, respectively.

In addition to two types of dampers being fully opened or closed, the damper may control a flow rate of air by controlling a degree of opening and closing.

In an example embodiment, the damper may include one or more blades and one or more hinges constituting an axis of pivoting of each blade. For example, the 2-1 damper 2710 may include one or more hinges 2712, and each of the one or more blades 2711 may be pivoted with respect to the hinge 2712. The blade 2711 may be pivoted based on the hinge 2712 to open or close the damper 2710. The number, positions, or shapes of the blades and the hinges included in the damper is not limited to those shown in FIG. 8, and known types of dampers may be applied to the present disclosure.

In another example embodiment, the damper may open or close one or more openings at once, different from that shown in FIG. 8. For example, the damper may be formed to cover both the 2-1 opening 221 and the 2-2 opening 222 to simultaneously open or close the 2-1 opening 221 and the 2-2 opening 222. As another example, the damper may be formed to simultaneously open or close the openings 221, 222, 223, and 224 which may form the second entrance 22.

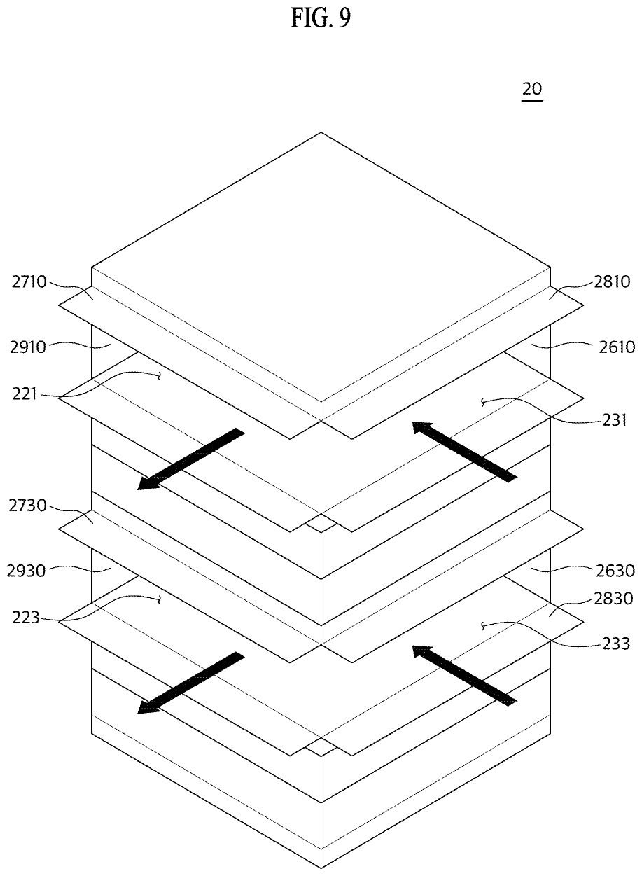

FIG. 9 is a diagram illustrating an example embodiment of the heat exchange dust collector 20 to which a plurality of dampers are applied.

Referring to FIG. 9, a 3-1 damper 2810 and the 2-1 damper 2710 may be opened, and a 1-1 damper 2610 and a 4-1 damper 2910 may be closed. In this case, the air flowing into between the first panel 201 and the second panel 202 through the 3-1 opening 231 may be guided by the closed 1-1 damper 2610, the 4-1 damper 2910, the inner inlet 13, the inner outlet 12, and the side wall (or a duct) of the air purifying apparatus 10 to be discharged between the first panel 201 and the second panel 202 through the 2-1 opening 221.

Referring to FIG. 9, a 3-3 damper 2830 and a 2-3 damper 2730 may be opened, and a 1-3 damper 2630 and a 4-3 damper 2930 may be closed. In this case, the air flowing into between the third panel 203 and the fourth panel 204 through the 3-3 opening 233 may be guided by the closed 1-3 damper 2630, the 4-3 damper 2930, the inner inlet 13, the inner outlet 12, and the side wall (or the duct) of the air purifying apparatus 10 to be discharged between the third panel 203 and the fourth panel 204 through the 2-3 opening 223.

Referring to FIG. 9, when the plurality of dampers are opened or closed as shown in FIG. 6, the internal air flowing into through the inner inlet 13 may flow into the heat exchange dust collector 20 through the third entrance 23, that is, the 3-1 opening 231 and the 3-3 opening 233, may be treated in the heat exchange dust collector 20, may be discharged from the heat exchange dust collector 20 through the second entrance 22, that is, the 2-1 opening 221 and the 2-3 opening 223, and may be discharged into the indoors through the inner outlet 12.

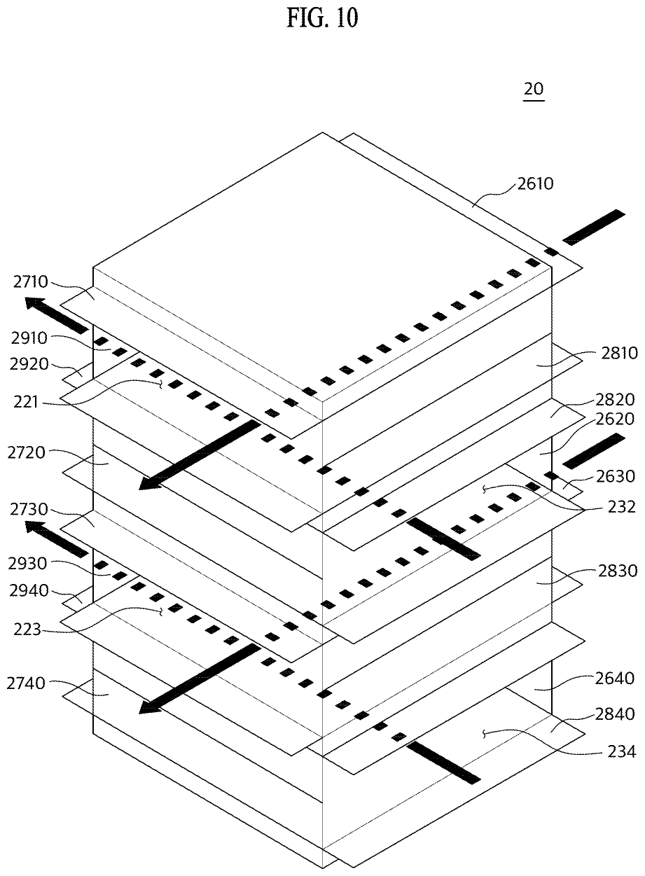

FIG. 10 is a diagram illustrating an example embodiment of the heat exchange dust collector 20 to which a plurality of dampers are applied.

Referring to FIG. 10, the 1-1 damper 2610 and the 2-1 damper 2710 may be opened, and a 3-1 damper 2810 and the 4-1 damper 2910 may be closed. In this case, the air flowing into between the first panel 201 and the second panel 202 through the 1-1 opening 211 may be guided by the closed 3-1 damper 2810, the 4-1 damper 2910 to be discharged between the first panel 201 and the second panel 202 through the 2-1 opening 221.

Referring to FIG. 10, a 1-3 damper 2630 and the 2-3 damper 2730 may be opened, and a 3-3 damper 2830 and a 4-3 damper 2930 may be closed. In this case, the air flowing into between the third panel 203 and the fourth panel 204 through the 1-3 opening 213 may be guided by the closed 3-3 damper 2830 and the closed 4-3 damper 2930 to be discharged between the third panel 203 and the fourth panel 204 through the 2-3 opening 223.

In addition, Referring to FIG. 10, the 3-2 damper 2820 and the 4-2 damper 2920 may be opened, and the 1-2 damper 2620 and the 2-2 damper 2720 may be closed. In this case, the air flowing into between the second panel 202 and the third panel 203 through the 3-2 opening 232 may be guided by the closed 1-2 damper 2620 and the closed 2-2 damper 2720 to be discharged between the second panel 202 and the third panel 203 through the 4-2 opening 242.

In addition, referring to FIG. 10, a 3-4 damper 2840 and the 4-4 damper 2940 may be opened, and a 1-4 damper 2640 and a 2-4 damper 2740 may be closed. In this case, the air flowing into between the fourth panel 204 and the fifth panel 205 through the 3-4 opening 234 may be guided by the closed 1-4 damper 2640 and the closed 2-4 damper 2740 to be discharged between the fourth panel 204 and the fifth panel 205 through the 4-4 opening 244.

As shown in FIG. 10, when the plurality of dampers are opened or closed, the internal air flowing into through the outer inlet 11 may flow into the heat exchange dust collector 20 through the first entrance 21, that is, the 1-1 opening 211 and the 1-3 opening 213, may be treated in the heat exchange dust collector 20, may be discharged from the heat exchange dust collector 20 through the second entrance 22, that is, the 2-1 opening 221 and the 2-3 opening 223, and may be discharged into the indoors through the inner outlet 12. In addition, the internal air flowing into through the inner inlet 13 may flow into the heat exchange dust collector 20 through the third entrance 23, that is, the 3-2 opening 232 and the 3-4 opening 234, may be treated in the heat exchange dust collector 20, may be discharged from the heat exchange dust collector 20 through the fourth entrance 24, that is, the 4-2 opening 242 and the 4-4 opening 244, and may be discharged into the indoors through the outer outlet 14 as shown in FIG. 1.

In an example embodiment, the air purifying apparatus 10 may further include a driver configured to open or close a damper. For example, the driver may open or close at least one among the dampers shown in FIG. 9 to operate the dampers to be opened or closed as shown in FIG. 10.

A change of the flow path may be implemented by the operation of the damper configured to open or close the opening as described above. Alternatively, the change of the flow path may be implemented by a partition wall having a movable opening as below.

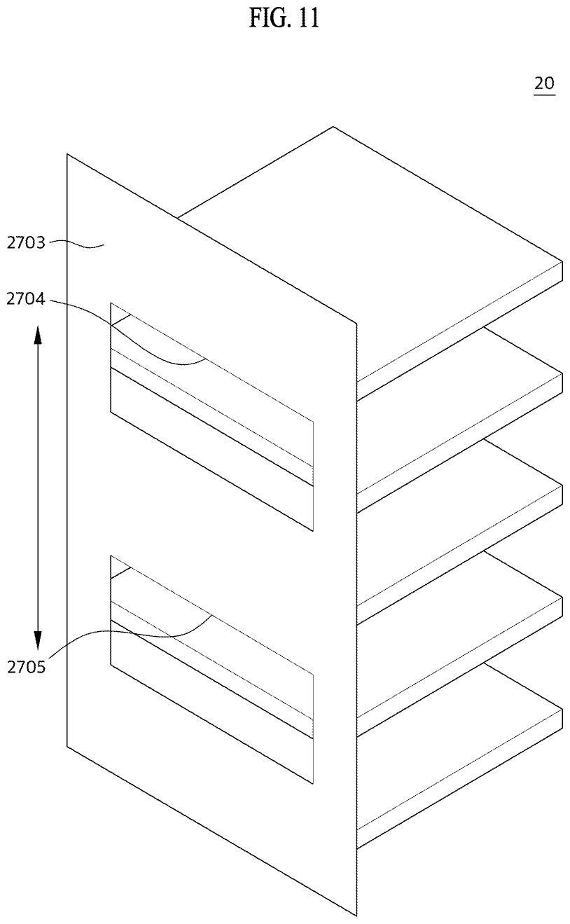

FIG. 11 is a diagram illustrating an example embodiment of the heat exchange dust collector 20 provided with a movable partition wall including an opening according to the present disclosure.

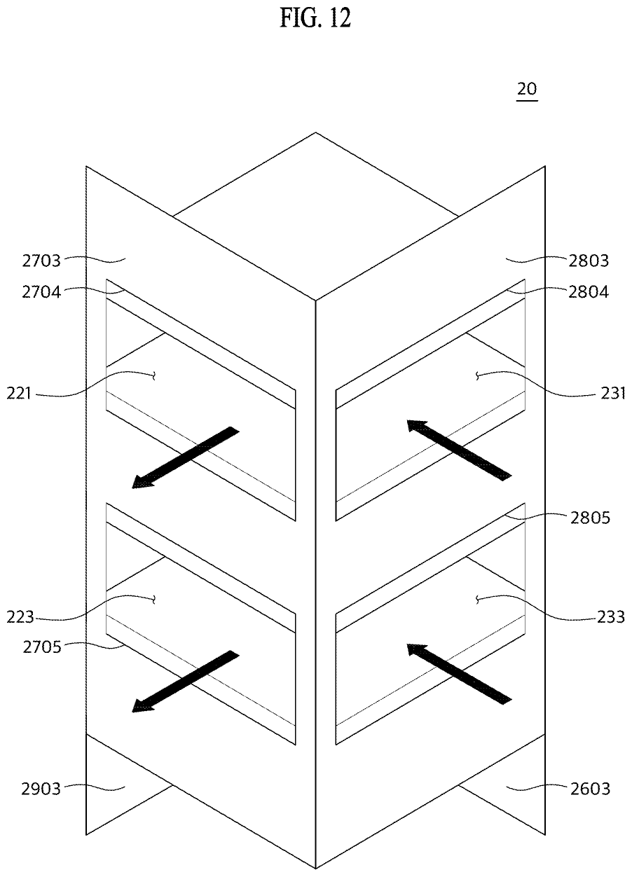

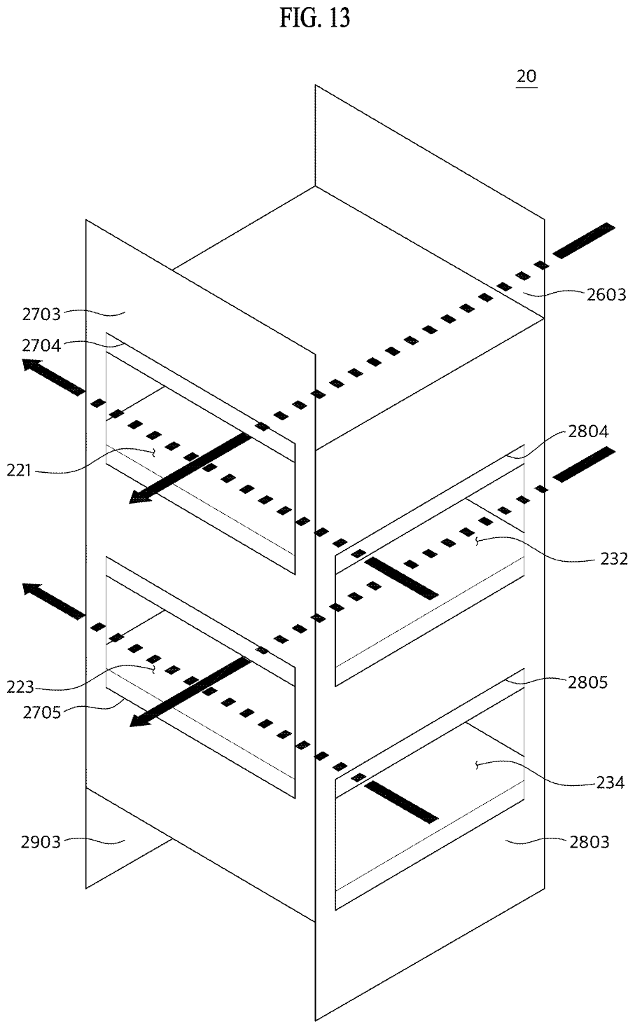

In an example embodiment, the partition wall may include one or more partition wall openings and may be moved in a stacking direction of the plurality of panels 201, 202, 203, 204, and 205 to selectively open and close openings between the plurality of panels 201, 202, 203, 204, and 205. For example, as shown in FIG. 11, a second movable partition wall 2703 with partition wall openings 2704 and 2705 is provided to be movable in the stacking direction of the panels so that it is possible to implement a state in which the 2-1 opening 221 and the 2-3 opening 223 are opened and closed, and the 2-2 opening 222 and the 2-4 opening 224 are closed or vice versa. In FIG. 11, although merely the partition wall 2703 is shown for explanation, a plurality of partition walls may be provided to correspond to the openings (or entrances) of the heat exchange dust collector 20 and may operate in the same manner. Specifically, the partition walls may be implemented in the form of FIG. 12 or 13.

FIGS. 12 and 13 show examples of a heat exchange dust collector to which a movable partition wall including an opening is applied.

Referring to FIG. 12, a third movable partition wall 2803 may be placed to open the 3-1 opening 231 for a space between the first panel 201 and the second panel 202 and close the 3-2 opening 232 for a space between the second panel 202 and the third panel 203. For example, the third movable partition wall 2803 may be placed such that a 3-1 partition wall opening 2804 and a 3-2 partition wall opening 2805 formed in the third movable partition wall 2803 are placed to correspond to the 3-1 opening 231 and the 3-3 opening 233, respectively to open the 3-1 opening 231 and the 3-3 opening 233 and to close the 3-2 opening 232 and the 3-4 opening 234. In addition, a second movable partition wall 2703 may be placed such that a 2-1 partition wall opening 2704 and a 2-2 partition wall opening 2705 formed in the second movable partition wall 2703 are placed to correspond to the 2-1 opening 221 and the 2-3 opening 223, respectively to open the 2-1 opening 221 and the 2-3 opening 223 and to close the 2-2 opening 222 and the 2-4 opening 224.

In addition, a first movable partition wall 2603 may be placed to close the 1-1 opening 211 and the 1-3 opening 213, and a fourth movable partition wall 2903 may be placed to close in the 4-1 opening 241 and the 4-2 opening 243.

When the movable partition walls 2603, 2703, 2803, and 2903 placed as shown in FIG. 12, the internal air flowing into through the inner inlet 13 may flow into the heat exchange dust collector 20 through the third entrance 23 as shown in FIG. 6, that is, the 3-1 opening 231 and the 3-3 opening 233, may be treated in the heat exchange dust collector 20, may be discharged from the heat exchange dust collector 20 through the second entrance 22, that is, the 2-1 opening 221 and the 2-3 opening 223, and may be discharged into the indoors through the inner outlet 12.

Referring to FIG. 13, the first movable partition wall 2603 may be placed such that a 1-1 partition wall opening and a 1-2 partition wall opening formed in the first movable partition wall 2603 are placed to correspond to the 1-1 opening 211 and the 1-3 opening 213, respectively, to open the 1-1 opening 211 and the 1-3 opening 213 and to close the 1-2 opening 212 and the 1-4 opening 214.

In addition, the second movable partition wall 2703 may be placed such that the 2-1 partition wall opening 2704 and the 2-2 partition wall opening 2705 formed in the second movable partition wall 2703 are placed to correspond to the 2-1 opening 221 and the 2-3 opening 223, respectively, to open the 2-1 opening 221 and the 2-3 opening 223 and to close the 2-2 opening 222 and the 2-4 opening 224.

In addition, referring to FIG. 13, the third movable partition wall 2803 may be placed such that the 3-1 partition wall opening 2804 and the 3-2 partition wall opening 2805 formed in the third movable partition wall 2803 are placed to correspond to the 3-2 opening 232 and the 3-4 opening 234, respectively, to open the 3-2 opening 232 and the 3-4 opening 234 and to close the 3-2 opening 231 and the 3-3 opening 233.

In addition, a fourth movable partition wall 2903 may be placed such that a 4-1 partition wall opening and a 4-2 partition wall opening formed in the fourth movable partition wall 2903 are placed to correspond to the 4-2 opening 242 and the 4-4 opening 244, respectively, to open the 4-2 opening 242 and the 4-4 opening 244 and to close the 4-1 opening 241 and the 4-3 opening 243.

When the movable partition walls 2603, 2703, 2803, and 2903 placed as shown in FIG. 13, the external air flowing into through the outer inlet 11 may flow into the heat exchange dust collector 20 through the 1-1 opening 211 and the 1-3 opening 213, may be treated in the heat exchange dust collector 20, may be discharged from the heat exchange dust collector 20 through the 2-1 opening 221 and the 2-3 opening 223, and may be discharged into the indoors through the inner outlet 12 as shown in FIG. 1. In addition, the internal air flowing into through the inner inlet 13 may flow into the heat exchange dust collector 20 through the 3-2 opening 232 and the 3-4 opening 234, may be treated in the heat exchange dust collector 20, may be discharged from the heat exchange dust collector 20 through the 4-2 opening 242 and the 4-4 opening 244, and may be discharged into the indoors through the outer outlet 14.

In an example embodiment, the air purifying apparatus 10 may further include a driver configured to move a movable partition wall. For example, the driver may operate to move at least one of the movable partition walls shown in FIG. 12 (that is, the first movable partition wall 2603 and the third movable partition wall 2803) to place the at least one movable partition wall as shown in FIG. 13.

In the example embodiments corresponding to FIGS. 12 and 13, an example in which the opening and closing of the opening is repeated over four layers is exemplified, but it may be implemented in the form of more or fewer layers, as necessary. Even in this case, the pattern in which the opening and closing of the opening is repeated in the stacking direction is preferably implemented in the same way, and the movable partition wall may be moved by driving of the driver.

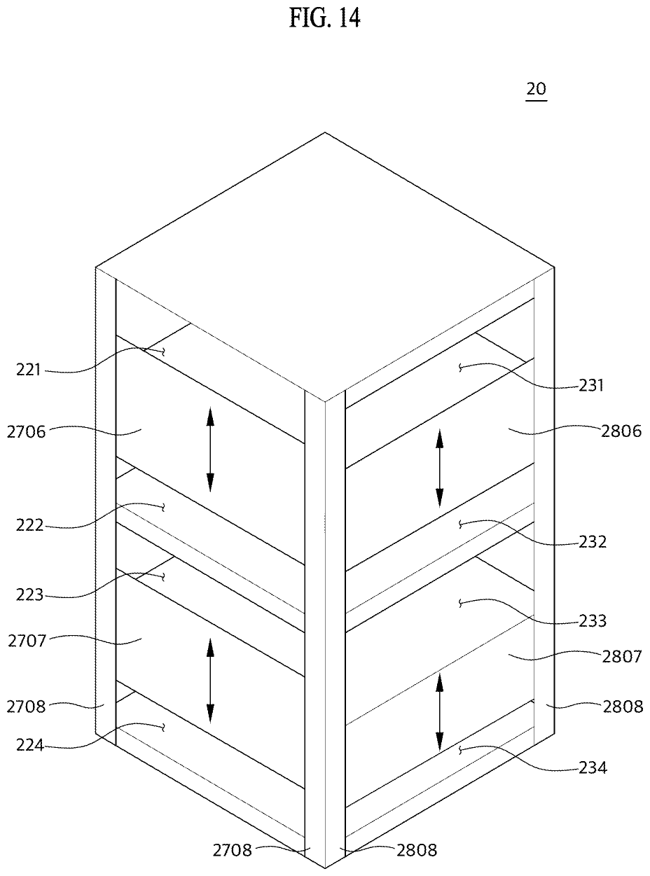

FIG. 14 is a diagram illustrating an example embodiment of the heat exchange dust collector and the partition wall according to the present disclosure.

As a modification of the example embodiments of FIGS. 11 to 13, instead of a movable partition wall with an opening, a plurality of movable partition walls are separately provided, and the driver of the flow path change part may move the movable partition walls to open or close the openings as needed, thereby form a flow path.

In an example embodiment, the heat exchange dust collector 20 may include rails 2708 and 2808 provided in the stacking direction of the plurality of panels, and movable partition walls 2706, 2707, 2806, and 2807 movable along the rails 2708 and 2808.

For example, a 2-1 movable partition wall 2706 and a 2-2 movable partition wall 2707 may be moved along the second rail 2708 in the stacking direction of the plurality of panels to close all or some of one or more among the 2-1 opening 221, the 2-2 opening 222, the 2-3 opening 223, and the 2-4 opening 224.

In addition, a 3-1 movable partition wall 2806 and a 3-2 movable partition wall 2807 may be moved along the third rail 2808 in a direction crossing the plurality of panels to close all or some of one or more of the 3-1 opening 231, the 3-2 opening 232, the 3-3 opening 233, and the 3-4 opening 234.

In an example embodiment, the air purifying apparatus 10 may further include a driver configured to move a movable partition wall. The driver properly locates the movable partition wall so that, as shown in FIG. 1, the external air flowing into through the outer inlet 11 may flow into the heat exchange dust collector 20 and then may be treated in the heat exchange dust collector 20 to be discharged into the indoors through the inner outlet 12, or the internal air flowing into through inner inlet 13 may flow into heat exchange dust collector 20 and then may be treated in the heat exchange dust collector 20 to be discharged into the indoors through the inner outlet 12.

In accordance with the present disclosure, external air may be supplied to an indoor space, and internal air may be discharged to the outdoors.

In addition, in accordance with the present disclosure, an air purifying apparatus may collect foreign materials in the air and, simultaneously, perform heat exchange between external air and internal air which intersect with each other.

In addition, according to the present disclosure, the air purifying apparatus may simultaneously perform an air purification function, a ventilation function, and a heat exchange function between the internal air and the external air, and thus there is no need to provide a separate energy recovery ventilation (ERV) so that there is an advantage of reducing manufacturing costs and increasing space utilization.

In addition, in accordance with the present disclosure, since the air purifying apparatus photoionizes and collects foreign materials in the air, there is an advantage being capable of effectively removing smaller foreign materials, for example, bacteria or viruses, compared to when a filter such as a high efficiency particulate air (HEPA) filter is used. In addition, since a differential pressure in the air purifying apparatus is reduced compared to when a filter such as a HEPA filter is used, a blower having a lower force may be used in the air purifying apparatus, and thus there is an advantage in that the noise and vibration of the air purifying apparatus may be reduced or minimized.

It is noted that effects of the present disclosure are not limited to the above-described effect, and other effects of the present disclosure will be apparent to those skilled in the art from the appended claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. An air purifying apparatus for purifying internal air, the air purifying apparatus comprising:
an outer inlet which forms a flow path through which external air flows into the air purifying apparatus;
an inner inlet which forms a flow path through which internal air flows into the air purifying apparatus;
an outer outlet which forms a flow path through which air inside the air purifying apparatus is discharged to the outdoors;
a charge part configured to ionize particles in the air flowing into the air purifying apparatus;
a heat exchange dust collector configured to:
perform heat exchange between the air flowing into through the outer inlet and the air flowing into through the inner inlet,
collect the ionized particles, and
treat air inside the air purifying apparatus; and
an inner outlet which forms a flow path through which the treated air is discharged into the indoors.

2. The air purifying apparatus of claim 1, wherein the heat exchange dust collector includes:
an external air flow path which is a flow path through which the air flowing into through the outer inlet flows; and
an internal air flow path which is a flow path through which the air flowing into through the inner inlet flows,
wherein a wall surface of the external air flow path and a wall surface of the internal air flow path have electrical conductivity, and
wherein the wall surface of the external air flow path and the wall surface of the internal air flow path are thermally connected to each other.

3. The air purifying apparatus of claim 2, wherein the heat exchange dust collector is formed such that the external air flow path and the internal air flow path are arranged in any one among a parallel flow manner, a counter flow manner, and a cross flow manner.

4. The air purifying apparatus of claim 1, wherein the charge part includes an electromagnetic wave generator provided with an emitter of a carbon nanotube material.

5. The air purifying apparatus of claim 1, further comprising:
a flow path change part,
wherein the flow path change part allows the air flowing into through the outer inlet to be treated through the heat exchange dust collector and then to be discharged into the indoors through the inner outlet or allows the air flowing into through the inner inlet to be treated through the heat exchange dust collector and then to be discharged into the indoors through the inner outlet.

6. The air purifying apparatus of claim 5, wherein the flow path change part includes a damper.

7. The air purifying apparatus of claim 6, wherein the flow path change part further includes a driver configured to drive the damper.

8. The air purifying apparatus of claim 1, wherein:
the heat exchange dust collector includes a plurality of panels stacked and arranged in a state of being spaced apart from each other;
at least one surface of each of the plurality of panels has electrical conductivity;
at least some of openings formed between the plurality of panels forms an entrance; and
the formed entrance communicates with the outer inlet, the inner inlet, the outer outlet, and the inner outlet to form a flow path for air treatment.

9. The air purifying apparatus of claim 8, wherein the heat exchange dust collector further includes a partition wall which forms a flow path by closing an area excluding the entrance among the openings formed between the plurality of panels.

10. The air purifying apparatus of claim 8, wherein the heat exchange dust collector further includes a flow path change part configured to open or close at least some of the openings formed between the plurality of panels.

11. The air purifying apparatus of claim 10, wherein the flow path change part includes a partition wall in the form of a damper configured to open and close at least some of the openings formed between the plurality of panels.

12. The air purifying apparatus of claim 10, wherein the flow path change part includes:
a movable partition wall including a partition wall opening configured to open or close at least some of the openings formed between the plurality of panels; and
a driver configured to move the movable partition wall in a stacking direction of the plurality of panels and change an opening/closing state of the at least some openings.

13. The air purifying apparatus of claim 1, further comprising:
a blower generating a flow from the heat exchange dust collector to the inner outlet.

14. The air purifying apparatus of claim 1, wherein the charge part is located between the outer inlet and the heat exchange dust collector and between the inner inlet and the heat exchange dust collector.
